(19) United States
(12) Patent Application Publication
(10) Pub. No.: US 2017/0091716 A1
(43) Pub. Date: Mar. 30, 2017

(54) SYSTEM AND METHOD OF AN ONLINE MARKETPLACE FOR HEALTHCARE SERVICES

(71) Applicant: Christopher Adam Gates, Cary, NC (US)

(72) Inventor: Christopher Adam Gates, Cary, NC (US)

(21) Appl. No.: 15/189,679

(22) Filed: Jun. 22, 2016

Related U.S. Application Data
(60) Provisional application No. 62/232,737, filed on Sep. 25, 2015.

(51) Int. Cl. G06Q 10/10; G06F 19/00

(52) U.S. Cl. CPC G06Q 10/1095; G06F 19/328

(57) ABSTRACT

A system and method of providing an online marketplace for healthcare services is provided. The present invention displays a plurality of names of doctors on an appointment scheduling platform. Each of the names of doctors has a cost for an initial appointment. The appointment scheduling platform is viewable by at least one customer. The customer selects one of the names of the doctors on the appointment scheduling platform, thereby scheduling an appointment with a doctor. The doctor provides a recommended test. The customer may then select a cost for the recommended test. A plurality of test costs for the recommended test is displayed on a testing platform. The testing platform is viewable by the customer. The customer selects one of the costs for the recommended test on the testing platform. The customer pays the cost and is tested.

### CROSS-REFERENCE TO RELATED APPLICATION

This application claims the benefit of priority of U.S. provisional application No. 62/232,737, filed Sep. 25, 2015, the contents of which are herein incorporated by reference.

### BACKGROUND OF THE INVENTION

The present invention relates to system and method of creating an online marketplace for healthcare services.

In the United States healthcare market, there is no price signal. Customers are told after they purchase services what they may cost, so there are no competitive price pressures to reduce costs.

As can be seen, there is a need for a method of creating an online marketplace for healthcare services.

### SUMMARY OF THE INVENTION

In one aspect of the present invention, a method of providing an online marketplace for healthcare services comprises the steps of: displaying a plurality of names of doctors each comprising a cost for an initial appointment on an appointment scheduling platform via software running on a computer, wherein the appointment scheduling platform is viewable by at least one customer; selecting one of the names of the doctors on the appointment scheduling platform via software running on a computer, thereby scheduling an appointment with a doctor, wherein the doctor provides a recommended test; displaying a plurality of test costs for the recommended test on a testing platform via software running on the computer, wherein the testing platform is viewable by the customer; and selecting one of the costs for the recommended test on the testing platform via software running on a computer, wherein the customer pays the cost and is tested.

In another aspect of the present invention, a system of providing an online marketplace for healthcare services comprises: at least a first computer comprising a memory, a processor and a user interface, wherein the processor: produces an appointment scheduling platform on the user interface, wherein the appointment scheduling platform comprises a plurality of names of doctors each comprising a cost for an initial appointment; receives a selection of one of the names of doctors by a customer and thereby schedules an appointment with a doctor, wherein the doctor provides a recommended test; produces a testing platform on the user interface, wherein the testing platform comprises a plurality of test costs for the recommended test; and receives a selection of one of the costs for the recommended test by the customer, wherein the customer pays the cost and is tested.

In another aspect of the present invention, a method of providing an online marketplace for healthcare services comprises the steps of: displaying a plurality of names of doctors each comprising a cost for an initial appointment on an appointment scheduling platform via software running on a computer, wherein the appointment scheduling platform is viewable by at least one customer; selecting one of the names of the doctors on the appointment scheduling platform via software running on a computer, thereby scheduling an appointment with a doctor, wherein the doctor provides a recommended treatment; displaying a plurality of treatment costs for the recommended treatment on a treatment platform via software running on the computer, wherein the treatment platform is viewable by the customer; and selecting one of the costs for the recommended treatment on the treatment platform via software running on a computer, wherein the customer pays the cost and is treated.

These and other features, aspects and advantages of the present invention may become better understood with reference to the following drawings, description and claims.

### BRIEF DESCRIPTION OF THE DRAWINGS

FIG. 1 is a schematic view of an embodiment of the present invention;

FIG. 2 is a flow chart of an embodiment of the present invention; and

FIG. 3 is a continuation of the flow chart of FIG. 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The present invention includes a healthcare software solution that adds a competitive free market price signal to the healthcare market. The present invention adds a price signal to the healthcare market that signals before services are bought how much they cost. The present invention adds a competitive free market forces to healthcare market and reduce costs. Information technology maybe used to convey the information.

The present invention may include a system and method of providing an online marketplace for healthcare services. The system and method may include displaying a plurality of names of doctors on an appointment scheduling platform via software running on a computer. Each of the names of doctors has a cost for an initial appointment. The appointment scheduling platform is viewable by at least one customer. The customer selects one of the names of the doctors on the appointment scheduling platform via software running on a computer, thereby scheduling an appointment with a doctor. The doctor provides a recommended test.

The present invention may further allow the customer to select a second opinion doctor. In such embodiments, a plurality of names of doctors is displayed on a second opinion platform via software running on the computer. Each of the names of the doctors has a cost for a second opinion appointment. The second opinion platform is viewable by the customer after the doctor provides the recommended test. The customer selects one of the names of the doctors on the second opinion platform via software running on a computer, thereby scheduling an appointment with a doctor. The doctor provides a second opinion.

The customer may then select a cost for the recommended test. A plurality of test costs for the recommended test is displayed on a testing platform via software running on the computer. The testing platform is viewable by the customer. The customer selects one of the costs for the recommended test on the testing platform via software running on a computer. The customer pays the cost and is tested.

In certain embodiments, the results of the test are saved on a server accessible by the internet via software running on a computer. The test results are displayed to the customer via software running on the computer. A plurality of names of doctors each having a cost for a doctor's diagnosis appointment is displayed on a diagnosis appointment platform. The diagnosis appointment platform is viewable by the customer. The customer selects one of the names of the doctors on the diagnosis platform via software running on a computer, thereby scheduling a diagnosis appointment with a doctor. The doctor determines a treatment option.

The present invention may further allow the customer to select another second opinion doctor. In such embodiments, a plurality of names of doctors is displayed on a second opinion platform via software running on the computer. Each of the names of the doctors has a cost for a second opinion appointment. The second opinion platform is viewable by the customer after the doctor provides the treatment option. The customer selects one of the names of the doctors on the second opinion platform via software running on a computer, thereby scheduling an appointment with a doctor. The doctor provides a second opinion.

The present invention may further include displaying a plurality of treatment costs for the treatment option on a treatment platform via software running on a computer. The treatment platform is viewable by the customer. The customer may then select one of plurality of treatment costs on the treatment platform via software running on a computer. The customer pays for the cost and is treated.

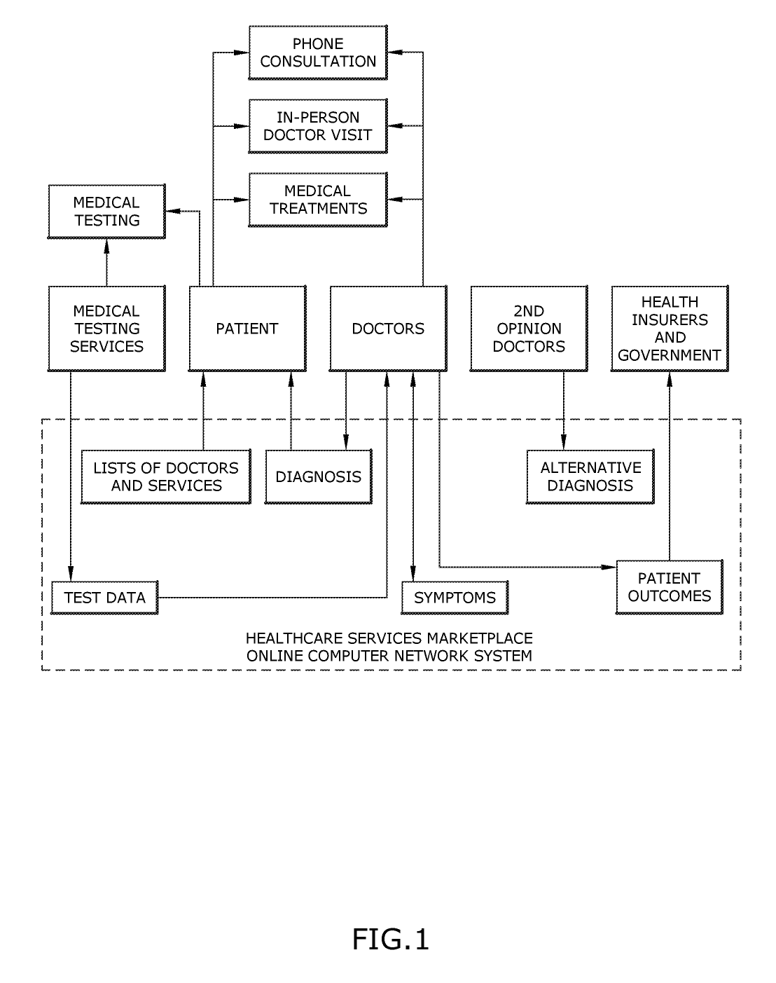

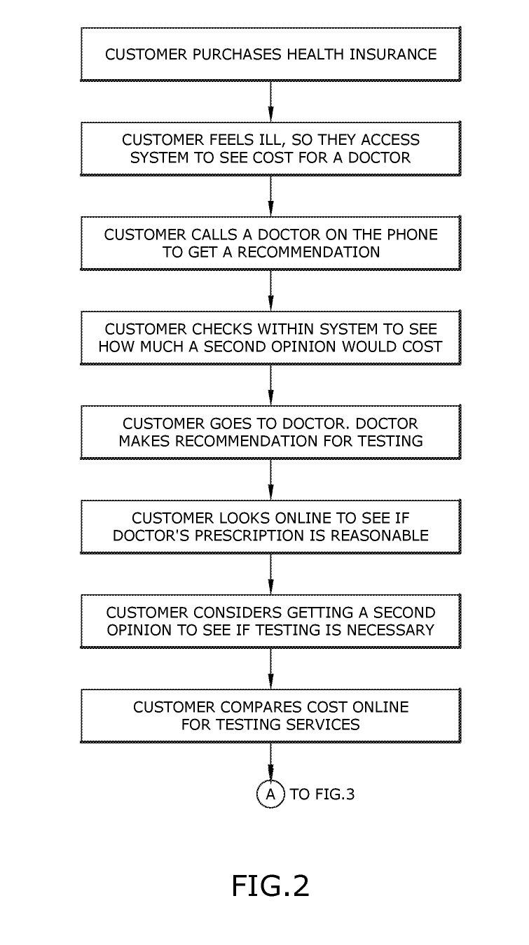

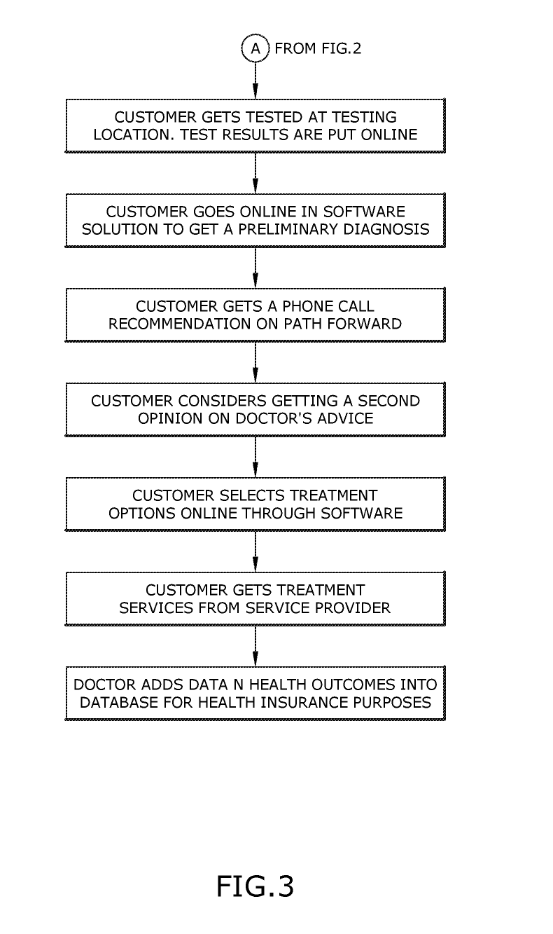

Referring to FIGS. 1 through 3, the present invention may include the following steps:
1. Customer purchases health insurance and gets right to enter a healthcare service marketplace.
2. Customer feels ill, so they may access system to see costs for a doctor recommendation.
3. Customer calls a doctor on the phone to get a recommendation on what type of doctor to see.
4. Customer checks within system to see how much a ‘second opinion’ to the first ‘on phone’ doctor's recommendation costs and decides if second opinion necessary.
5. Customer looks online through software to see the costs for the recommended doctor visit. Customer selects the preferred doctor based on cost and other factors.
6. Customer goes to doctor. Doctor makes recommendation for testing to do. Doctor inputs diagnosis and recommendations online.
7. Customer looks online to see if doctor's prescription is reasonable by looking through online information.
8. Customer considers getting a second opinion to see if testing is necessary or sufficient.
9. Customer compares costs online through software for testing services by different firms and books an appointment with a medical testing service.
10. Customer gets tested at testing location. Test results are put online in software system. All data is put under an anonymous personal identification number.
11. Customer goes online in software solution to get a preliminary diagnosis based on test results by comparing service costs between providers.
12. Customer gets a phone call recommendation on path forward.
13. Customer considers getting a second opinion on doctor's advice.
14. Customer selects treatment options online through software solution and books appointment.
15. Customer gets treatment services from service provider.
16. Doctor adds data on health outcomes into database for health insurance analytics to improve future healthcare outcomes.

The software creates an online marketplace for services where doctors, hospitals, medical testing companies, customers, and health insurers can buy and sell services. This provides visibility to costs to increase competitive pressure and reduce costs. Each diagnosis made by a doctor may have the option to get a second opinion from another doctor by making the information available within the system. There may be a legal disclaimer to reduce frivolous lawsuits within the system before each service. Service providers may determine what prices to enter into the system and health insurers may determine the deductibles. The system may provide information freely available for customers so they can better understand their diagnosis, treatments, and testing options. Outcomes maybe stored in the database of a server so an analysis can be conducted to improve future health outcomes.

The health insurance companies, customers, and service providers may enter their information into the database. The customers may select a provider. The health insurance companies may collect data and provide information on deductibles and health insurance premiums. The service providers may provide diagnosis, testing, treatments, and also list prices for all of their services on the internet. Doctors may have the option of examining existing data within the database and even conducting another examination to provide a second opinion so that doctor's could be held more accountable. Customers, health insurers, and doctors may work together through legal disclaimers in the system to reduce lawsuits and negligence by having an electronic legal document approved with each treatment. The health insurance companies may manage the analytics on health outcomes for various treatments and also manage the electronic health records for the customers.

A method of using the present invention may include the following. Customers access the online marketplace. They see the cost for various services and then select those services, which could be: calling a doctor, visiting a doctor, getting testing procedures, getting treatments, etc. Health insurers access the data in the system to analyze which treatments and tests are most effective along with costs. Service providers put the costs for various services into the database. Service providers also input their diagnosis and recommendations and information about patients into the database so the information follows the customer/patient.

The analytics from the database could provide recommendations for cost effectiveness on treatments. The analytics from the database could recommend better treatments and analyze the outcomes to see if there are unintended side effects from certain treatments. The data within the system could also be used to create automated ‘diagnosis’ whereby computer themselves use the data to determine a diagnosis instead of a human doctor. So the data could be used to create electronic aides for doctors to help them make diagnosis.

In alternate embodiments, the present invention may include the following. The health insurers themselves could purchase the services on behalf of the customers themselves. Health insurers could input the costs of services provided by service providers into the database for them. Health insurers could provide their own ‘doctor second opinions’ to check the diagnosis of the first doctor.

Sub-routines and codes may be written to create the present invention. The software solution creates an online marketplace for healthcare services. Customers may be given a diagnosis for a healthcare service. Then customers may select between different providers based on cost which provider they prefer. The customers may also have the option of getting a second opinion from another doctor about their diagnosis to provide service provider accountability.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A method of providing an online marketplace for healthcare services comprising the steps of:
displaying a plurality of names of doctors each comprising a cost for an initial appointment on an appointment scheduling platform via software running on a computer, wherein the appointment scheduling platform is viewable by at least one customer;
selecting one of the names of the doctors on the appointment scheduling platform via software running on a computer, thereby scheduling an appointment with a doctor, wherein the doctor provides a recommended test;
displaying a plurality of test costs for the recommended test on a testing platform via software running on the computer, wherein the testing platform is viewable by the customer; and
selecting one of the costs for the recommended test on the testing platform via software running on a computer, wherein the customer pays the cost and is tested.

2. The method of claim 1, further comprising the step of:
displaying a plurality of names of doctors each comprising a cost for a second opinion on a second opinion platform via software running on the computer, wherein the second opinion platform is viewable by the customer after the doctor provides the recommended test.

3. The method of claim 1, further comprising the steps of:
saving a results of the test on a server accessible by the internet via software running on a computer; and
displaying the results of the test to the customer via software running on the computer.

4. The method of claim 3, further comprising the step of:
displaying a plurality of names of doctors each comprising a cost for a doctor's diagnosis appointment on a diagnosis appointment platform via software running on the computer, wherein the diagnosis appointment platform is viewable by the customer.
selecting one of the names of the doctors on the diagnosis platform via software running on a computer, thereby scheduling a diagnosis appointment with a second doctor, wherein the second doctor determines a treatment option.

5. The method of claim 4, further comprising the steps of:
displaying a plurality of treatment costs for the treatment option on a treatment platform via software running on a computer, wherein the treatment platform is viewable by the customer; and
selecting one of plurality of treatment costs on the treatment platform via software running on a computer, wherein the customer pays for the cost and is treated.

6. A system of providing an online marketplace for healthcare services comprising:
at least a first computer comprising a memory, a processor and a user interface, wherein the processor:
produces an appointment scheduling platform on the user interface, wherein the appointment scheduling platform comprises a plurality of names of doctors each comprising a cost for an initial appointment;
receives a selection of one of the names of doctors by a customer and thereby schedules an appointment with a doctor, wherein the doctor provides a recommended test;
produces a testing platform on the user interface, wherein the testing platform comprises a plurality of test costs for the recommended test; and
receives a selection of one of the costs for the recommended test by the customer, wherein the customer pays the cost and is tested.

7. The system of claim 6, wherein the processor:
produces a second opinion platform on the user interface, wherein the second opinion platform comprises a plurality of names of doctors each comprising a cost for a second opinion appointment.

8. The system of claim 6, wherein the processor
stores a result of the test on a server accessible by the internet; and
displays the results of the test on the user interface to the customer.

9. The system of claim 8, wherein the processor
produces a diagnosis appointment platform on the user interface, wherein the diagnosis appointment platform comprises a plurality of names of doctors each comprising a cost for a diagnosis appointment; and
receives a selection of one of the plurality of names of doctors by the customer and thereby scheduling a diagnosis appointment with a doctor, wherein the doctor determines a treatment option.

10. The system of claim 9, wherein the processor
produces a treatment platform on the user interface, wherein the treatment platform comprises a plurality of treatment costs for the treatment; and
receives a selection of one of the treatment costs by the customer, wherein the customer pays for the cost and is treated.

11. A method of providing an online marketplace for healthcare services comprising the steps of:
displaying a plurality of names of doctors each comprising a cost for an initial appointment on an appointment scheduling platform via software running on a computer, wherein the appointment scheduling platform is viewable by at least one customer;
selecting one of the names of the doctors on the appointment scheduling platform via software running on a computer, thereby scheduling an appointment with a doctor, wherein the doctor provides a recommended treatment;
displaying a plurality of treatment costs for the recommended treatment on a treatment platform via software running on the computer, wherein the treatment platform is viewable by the customer; and
selecting one of the costs for the recommended treatment on the treatment platform via software running on a computer, wherein the customer pays the cost and is treated.
